(19) United States
(12) Patent Application Publication
(10) Pub. No.: US 2026/0198514 A1
(43) Pub. Date: Jul. 16, 2026

(54) GELLED CONFECTION COMPRISING A PUFA

(71) Applicant: DSM IP Assets B.V., MAASTRICHT (NL)

(72) Inventors: Gang SU, Ellicott City, MD (US); Zhenbo MA, Metuchen, NJ (US); Xiaoxiao CHEN, Millburn, NJ (US); Kristin BRANCATO, Doylestown, PA (US)

(73) Assignee: DSM IP Assets B.V., MAASTRICHT (NL)

(21) Appl. No.: 19/138,343

(22) PCT Filed: Dec. 12, 2023
(86) PCT No.: PCT/US2023/083550

§ 371 Date: Jun. 12, 2025

Related U.S. Application Data
(60) Provisional application No. 63/431,816, filed on Dec. 12, 2022.
(60) Provisional application No. 63/547,240, filed on Nov. 3, 2023.

(30) Foreign Application Priority Data
Mar. 9, 2023 (EP) 23160896.9

(51) Int. Cl. A23G 3/40; A23D 7/005; A23G 3/36; A23G 3/42; A23G 3/48; A23G 3/54; A23L 29/231; A23L 29/281

(52) U.S. Cl. CPC A23G 3/40; A23D 7/0053; A23G 3/368; A23G 3/42; A23G 3/48; A23G 3/54; A23L 29/231; A23L 29/284

(57) ABSTRACT

The present invention relates to a new formulation, which is a gelled confection, which comprises a high amount (concentration) of at least one PUFA. In an embodiment, a gelled confection comprises encapsulated particles comprising a coacervate shell encapsulating at least one PUFA, at least one gelling substance, and water, wherein the content of the at least one PUFA is at least 10 mg/g of the gelled confection.

### FIELD

The present invention relates to a new formulation, which is a gelled confection, which comprises a high amount (a high concentration) of at least one PUFA (Poly Unsaturated Fatty Acids).

### BACKGROUND

Gelled confections are confections such as gummy candies, jellies, gummy bears, (wine) gums etc. Such gelled confections are popular among consumers because they have an elastic texture, and they can be relatively easily flavored with a texture-matching flavor. Among the jellies, gummi candies are particularly popular for the chewy, elastic texture.

Such gelled confections (or gummy) confections can have a variety of forms, such as gelled bears, gelled worms, gelled frogs, gelled hamburgers, gummy cherries, gelled soda bottles, gelled sharks, gelled army men, gelled hippopotami, gelled lobsters, gelled water-melons, gelled octopuses, gelled apples, gelled peaches, and gelled oranges and many more. The gelled portion may form all or part of the confection, such as a gelled center covered with a shell of differing texture and chewiness. Also the sizes of the gelled confection can vary.

PUFAs (Poly Unsaturated Fatty Acids) are known in the art. Preferred poly-unsaturated fatty acids are those having from 16 to 24 carbon atoms, preferably from 18 to 22 carbon atoms, preferably with 18, 20 or 22 carbon atoms and having multiple unsaturated carbon-carbon double bonds.

Examples of such poly-unsaturated fatty acids are the known n-3 PUFA's. Preferred are for example poly-unsaturated acids such as n-3 PUFA, mainly as eicosapentaenoic acid (EPA), docosapentaenoic acid (DPA), docosahexaenoic acid (DHA), such as (cis-) 5,8,11,14,17-eicosapentanoic acid and/or (cis-) 4,7,10,13,16,19-docosahexaenic acid. Such PUFAs can be sourced from natural sources, such walnuts, algae, sunflower seeds, flax seeds, flax oil, fish (such as i.e. salmon, mackerel, herring, albacore tuna, and trout), corn oil, soybean oil, safflower oil. It is also possible to produce PUFA (bio) chemically for example by fermentation. PUFAs are available commercially from a variety of suppliers in a variety of forms.

PUFAs (especially the n-3 PUFAs) are known to have variety of health benefits against cardiovascular diseases (CVDs) including well-established hypotriglyceridemic and anti-inflammatory effects, healthy infant development and brain function in older adults. Also, various studies indicate promising antihypertensive, anticancer, antioxidant, antidepres-sion, antiaging, and antiarthritis effects. It is very beneficial to take an amount of about at least 250 mg of (n-3) PUFAs for adults and about at least 120 mg to about 1300 mg for children.

A major problem of PUFAs is that PUFAs (independent from their source) have strong fishy flavor. This fishy flavor is a big challenge in view of product forms comprising any PUFA. Furthermore, due to the fact that PUFAs have a tendency to oxidize easily, which leads to an intensified flavor when product formulations are produced using, for example, elevated production temperatures.

When using a high amount of PUFA the strong fishy flavor is a major problem. Many peo-ple (especially children) detest the fishy flavor. However, due to the importance of PUFAs there is a need for formulations, which have a high amount of PUFA, but which do not have the fishy flavor.

### SUMMARY

Surprisingly, it was found out that a specific gelled confection and the process to produce them allow to provide gelled confection with a high amount of PUFA's.

The present invention relates to gelled confection (GC) comprising:
(i) encapsulated particles comprising a coacervate shell encapsulating at least one PUFA,
(ii) at least one gelling substance (such as pectin, starch, gelatin, or other hydrocolloids), and
(iii) water,
   wherein the content of the at least one PUFA is at least 10 mg/g of the gelled confection.

Ideally, the size of the confection is designed in such a way that a small number of such gelled confection need to be consumed to reach to recommended daily dosage of PUFA.

### DETAILED DESCRIPTION

Preferably, the gelled confection according to the present invention comprises at least one PUFA chosen from the group consisting of PUFA having from 16 to 24 carbon atoms and having multiple unsaturated carbon-carbon double bonds.

More preferably, the gelled confection according to the present invention comprises at least one PUFA chosen from the group consisting of PUFA having from 18 to 22 carbon atoms and having multiple unsaturated carbon-carbon double bonds.

Even more preferably the gelled confection according to the present invention comprises at least one PUFA chosen from the group consisting of PUFA having 18, 20 or 22 carbon atoms and having multiple unsaturated carbon-carbon double bonds.

Most preferably, the gelled confection according to the present invention comprises at least one PUFA chosen from the group consisting of eicosapentaenoic acid (EPA), docosapentaenoic acid (DPA) and docosahexaenoic acid (DHA).

Therefore, the present invention also relates to a gelled confection (GC1), which is gelled confection (GC), wherein the at least one PUFA is chosen from the group consisting of PUFA having from 16 to 24 carbon atoms and having multiple unsaturated carbon-carbon double bonds.

Therefore, the present invention also relates to a gelled confection (GC1′), which is gelled confection (GC), wherein the at least one PUFA is chosen from the group consisting of PUFA having from 18 to 22 carbon atoms and having multiple unsaturated carbon-carbon double bonds.

Therefore, the present invention also relates to a gelled confection (GC1″), which is gelled confection (GC), wherein the at least one PUFA is chosen from the group consisting of PUFA having 18, 20 or 22 carbon atoms and having multiple unsaturated carbon-carbon double bonds.

Therefore, the present invention also relates to a gelled confection (GC1′″), which is gelled confection (GC), wherein the at least one PUFA is chosen from the group consisting of eicosapentaenoic acid (EPA), docosapentaenoic acid (DPA) and docosahexaenoic acid (DHA).

The overall content of the PUFA in the gelled confection is at least 10 mg/gram of the gelled confection. A preferred range is 10-60 mg/gram of the gelled confection.

Therefore, the present invention also relates to a gelled confection (GC1″), which is gelled confection (GC), wherein the overall content of the PUFA in the gelled confection is 10-100 mg/gram of the gelled confection.

The PUFA is encapsulated within a coacervate shell. Use of such encapsulated particles within the context of the present invention may lead to improvements in shelf-life, stability, or sensory performance over PUFAs present in its oily form or as an alternative powder form. An example of such a PUFA powder is life's® Omega O33-P100 from DSM Nutri-tional Products Ltd. In an embodiment, the encapsulated particles comprising a coacervate shell encapsulating a PUFA are present in an amount of from 8, 10, 12, or 15 wt % to 25, 22, 20, 18, or 16 wt %, based on the total weight of the gelled confection.

In an embodiment, the coacervate comprises at least one polymer. In an embodiment, the polymer comprises a gelatin, polyphosphate, a polysaccharide, or and mixtures thereof. In an embodiment, the coacervate comprises gelatin type A, gelatin type B, polyphosphate, gum Arabic, alginate, chitosan, carrageenan, pectin, carboxy methylcellulose (CMC), or a mixture thereof.

In an embodiment, shell comprises a coacervate between two or more polymer components. In an embodiment, the two components are selected from the group consisting of a gelatin, a polyphosphate, a polysaccharide, and a mixture thereof. In an embodiment a first component is preferably gelatin type A. In an embodiment, the second component is preferably a gelatin type B, polyphosphate, gum Arabic, alginate, chitosan, carrageenan, pectin, carboxymethyl-cellulose or a mixture thereof. The molar ratio of the first component to the second component is typically from 1:5 to 15:1. For example, when gelatin type A and polyphosphate are used, the molar ratio of gelatin: polyphosphate may be from 8:1 to 12:1.

Processing aids may be included in the shell material. Processing aids may be used for a variety of reasons. For example, they may be used to promote is agglomeration of the primary encapsulated particles, control encapsulated particle size and/or to act as an antioxidant.

Such encapsulated particles comprising a coacervate shell encapsulating at least one PUFA can be obtained via an oil-in-water emulsion. For example, a gelatin and water solution is first formed and a PUFA oil, an antioxidant, and sodium polyphosphate are added. The composition is emulsified under high shear until particles are 1-2 μm. Acid is added to initiate the coating of the oil droplets with the gelatin/polyphosphate coacervate. Coated droplets attract, forming aggregates of 40-60 μm. The batch is cooled to solidify gelatin and an enzyme added to initiate cross-linking. Cross-linking may improve thermal and pH stability. Following cross-linking, the mixture is centrifuged to reduce water content and cut drying time. An anti-caking agent is added prior to spraying the slurry into a dryer with hot air to remove moisture. The resulting powder of encapsulated particles comprising a coacervate shell encapsulating at least one PUFA is collected.

In an embodiment, the encapsulated particles have an average diameter of from 20 to 500 μm, preferably 20-250 μm, more preferably 30-150 μm.

The gelled confection according to the present invention comprises at least one gelling substance. Any commonly known gelling substance (or mixture of gelling substances), which are usually used in such gelled confections, can be used. Suitable gelling substance are gelatin (from any source), pectin (from any sources), starches (from any sources), other hydrocolloids (from any sources).

The amount of the gelling substance in the gelled confection is usually (and preferably) between 0.5 and 20 weight-% (wt-%), based on the total weight of the gelled confection. Preferably 0.5 to 10 wt-%, based on the total weight of the gelled confection.

Therefore, the present invention also relates to a gelled confection (GC2), which is gelled confection (GC), (GC1), (GC1′), (GC1″), (GC1″) or (GC1″), wherein the at least one gelling substance is chosen from the group consisting of gelatin, pectin, starches and hydrocolloids.

Therefore, the present invention also relates to a gelled confection (GC3), which is gelled confection (GC), (GC1), (GC1′), (GC1″), (GC1″), (GC1″) or (GC2), wherein the amount of the at least one gelling agent is between 0.5 and 20 wt-%, based on the total weight of the gelled confection.

Therefore, the present invention also relates to a gelled confection (GC3′), which is gelled confection (GC), (GC1), (GC1′), (GC1″), (GC1″), (GC1″) or (GC2), wherein the amount of the at least one gelling agent is between 0.5 to 10 wt-%, based on the total weight of the gelled confection.

The water content of the gelled confection according to the present invention is preferably between 5 and 30 wt-%, based on the total weight of the gelled confection. Preferably, the water moisture content of the gelled confection is in the range of 5 wt-% to 25 wt-%, based on the total weight of the gelled confection.

Therefore, the present invention also relates to a gelled confection (GC4), which is gelled confection (GC), (GC1), (GC1′), (GC1″), (GC1″), (GC1″), (GC2), (GC3) or (GC3′), wherein the water moisture content is between 5 and 30 wt-%, based on the total weight of the gelled confection.

Therefore, the present invention also relates to a gelled confection (GC4′), which is gelled confection (GC), (GC1), (GC1′), (GC1″), (GC1′″), (GC1″), (GC2), (GC3) or (GC3′), wherein the water moisture content is between 5 wt-% to 25 wt-%, based on the total weight of the gelled confection.

Furthermore, the gelled confection according to the present invention usually and preferably comprises sugar (monosaccharides and/or disaccharides).

Suitable monosaccharides and/or disaccharides are for example fructose, galactose, glucose lactose, maltose, and sucrose.

The amount of the monosaccharides and/or disaccharides in the gelled confection is usually (and preferably) between 10 and 50 wt-%, based on the total weight of the gelled confection. Preferably 15 to 45 wt-%, based on the total weight of the gelled confection.

Therefore, the present invention also relates to a gelled confection (GC5), which is gelled confection (GC), (GC1), (GC1′), (GC1″), (GC1″), (GC1″), (GC2), (GC3), (GC3′), (GC4) or (GC4′), wherein the gelled confection comprises at least one sugar (monosaccharides and/or disaccharides).

Therefore, the present invention also relates to a gelled confection (GC5′), which is gelled confection (GC5), wherein the monosaccharides and/or disaccharides is chosen from the group consisting of fructose, galactose, glucose lactose, maltose, and sucrose.

Therefore, the present invention also relates to a gelled confection (GC5″), which is gelled confection (GC5) or (GC5′), wherein the amount of the sugar (monosaccharides and/or disaccharides) in the gelled confection is between 10 and 50 wt-%, based on the total weight of the gelled confection.

Therefore, the present invention also relates to a gelled confection (GC5″), which is gelled confection (GC5) or (GC5′), wherein the amount of the sugar (monosaccharides and/or disaccharides) in the gelled confection is between 15 to 45 wt-%, based on the total weight of the gelled confection.

Furthermore, the gelled confection according to the present invention usually and preferably comprises syrup (such as corn syrup, Molasses, cane or beet syrup, Malt extract, Honey, maple syrup, Agave, yacon, other starch syrups, Rice syrup, tapioca syrup, oat syrup, Soluble fiber).

The amount of the syrup in the gelled confection is usually (and preferably) between 10 and 50 wt-%, based on the total weight of the gelled confection. Preferably 15 to 45 wt-%, based on the total weight of the gelled confection.

Therefore, the present invention also relates to a gelled confection (GC6), which is gelled confection (GC), (GC1), (GC1′), (GC1″), (GC1″), (GC1″), (GC2), (GC3), (GC3′), (GC4), (GC4′), (GC5), (GC5′), (GC5″) or (GC5″), wherein the gelled confection comprises at least one syrup (such as corn syrup, molasses, cane or beet syrup, malt extract, honey, maple syrup, agave, yacon, rice syrup, tapioca syrup, oat syrup).

Therefore, the present invention also relates to a gelled confection (GC6′), which is gelled confection (GC6), wherein the amount of the syrup in the gelled confection is between 10 and 50 wt-%, based on the total weight of the gelled confection.

Therefore, the present invention also relates to a gelled confection (GC6″), which is gelled confection (GC6), wherein the amount of the syrup in the gelled confection is between 15 to 45 wt-%, based on the total weight of the gelled confection.

Instead of sugar, it is also possible to use sugar substitutes (sugar replacements). Such sugar replacements are well-known. Suitable sugar substitutes are i.e. sugar alcohols (such as glycerol, erythritol, arabitol, xylitol, mannitol, sorbitol, isomalt, maltitol and lactitol), fibers (such as soluble corn fibers, soluble tapioca fibers, inulin), and other sugar substitutes (such as allulose, acesulfame potassium, advantame, aspartame, neotame, saccharin, sucralose, cylamate and steviol glycosides (stevia))

When using such sugar replacements, they are present in the gelled confection according to the present invention in an amount of 20-80 wt-%, based on the total weight of the gelled confection (preferably 30-75 wt-%, based on the total weight of the gelled confection.

Therefore, the present invention also relates to a gelled confection (GC7), which is gelled confection (GC), (GC1), (GC1′), (GC1″), (GC1″), (GC1″), (GC2), (GC3), (GC3′), (GC4) or (GC4′), wherein the gelled confection comprises at least one sugar substitute.

Therefore, the present invention also relates to a gelled confection (GC7′), which is gelled confection (GC7), wherein the at least one sugar substitute is chosen from the group consisting of sugar alcohols, fiber and other sugar substitutes.

Therefore, the present invention also relates to a gelled confection (GC7″), which is gelled confection (GC7), wherein the at least one sugar substitute is chosen from the group consisting of glycerol, erythritol, arabitol, xylitol, mannitol, sorbitol, isomalt, maltitol lactitol, corn fiber, soluble tapioca fiber, inulin, allulose, acesulfame potassium, advantame, aspartame, neotame, saccharin, sucralose, cylamate and steviol glycosides (stevia).

Therefore, the present invention also relates to a gelled confection (GC7″), which is gelled confection (GC7), (GC7′) or (GC7″), wherein the amount of the at least one sugar substitute is in the gelled confection is between 10 to 80 wt-%, based on the total weight of the gelled confection.

Therefore, the present invention also relates to a gelled confection (GC7″ ″), which is gelled confection (GC7), (GC7′) or (GC7″), wherein the amount of the at least one sugar substitute is in the gelled confection is between 30 to 75 wt-%, based on the total weight of the gelled confection.

It is also possible to use a mixture of at least one sugar and/or at least one syrup and at least one sugar replacement.

The gelled confection according to the present invention can also comprise citric acid and/or at least one other acids (such as malic acid, etc).

Usually in an amount of 0.1 to 10 wt-%, based on the total weight of the gelled confection.

Therefore, the present invention also relates to a gelled confection (GC8), which is gelled confection (GC), (GC1), (GC1′), (GC1″), (GC1″), (GC1″), (GC2), (GC3), (GC3′), (GC4), (GC4′), (GC5), (GC5′), (GC5″), (GC5″), (GC6), (GC6′), (GC6″), (GC7), (GC7′), (GC7″), (GC7″) or (GC7″), wherein the gelled confection comprises citric acid and/or at least one other acid (such as malic acid).

Therefore, the present invention also relates to a gelled confection (GC8′), which is gelled confection (GC8), wherein the amount of the citric acid and/or of at least one other acid is 0.1 to 10 wt-%, based on the total weight of the gelled confection.

Usually, the gelled confection according to the present invention comprises at least one flavor ingredient as well. Such flavor can be natural ones as well as artificial ones (as well as a mixture thereof). The amount of such flavor ingredients can vary also due to the different intensity of flavor ingredients. Usually, the amount of such flavor ingredients is less than 5 wt-%, based on the total weight of the gelled confection. Preferably the amount is 0.01 to 5 wt-%, based on the total weight of the gelled confection.

Therefore, the present invention also relates to a gelled confection (GC9), which is gelled confection (GC), (GC1), (GC1′), (GC1″), (GC1″), (GC1″), (GC2), (GC3), (GC3′), (GC4), (GC4′), (GC5), (GC5′), (GC5″), (GC5″), (GC6), (GC6′), (GC6″), (GC7), (GC7′), (GC7″), (GC7″), (GC7″), (GC8) or (GC8′), wherein the gelled confection comprises at least one flavor ingredient.

Therefore, the present invention also relates to a gelled confection (GC9′), which is gelled confection (GC9), wherein the at least one flavor ingredient can be a natural flavor ingredient and/or an artificial flavor ingredient.

Therefore, the present invention also relates to a gelled confection (GC9″), which is gelled confection (GC9) or (GC9′), wherein the amount of such flavor ingredients is less than 5 wt-%, based on the total weight of the gelled confection.

Therefore, the present invention also relates to a gelled confection (GC9′″), which is gelled confection (GC9) or (GC9′), wherein the amount of such flavor ingredients is 0.01 to 5 wt-%, based on the total weight of the gelled confection, preferably 1 to 3 wt-%, based on the total weight of the gelled confection.

It is very common that the gelled confection has a color that fits to the flavor. Therefore, it is very common to add at least one coloring agent to the gelled confection according to the present invention. The coloring agent can be natural ones as well as artificial ones (as well as a mixture thereof). The amount of such coloring agent can vary also due to the different color intensity. Usually, the amount of such coloring agent is less than 1 wt-%, based on the total weight of the gelled confection. Preferably the amount is 0.01 to 1 wt-%, based on the total weight of the gelled confection.

Therefore, the present invention also relates to a gelled confection (GC10), which is gelled confection (GC), (GC1), (GC1′), (GC1″), (GC1″), (GC1″), (GC2), (GC3), (GC3′), (GC4), (GC4′), (GC5), (GC5′), (GC5″), (GC5″), (GC6), (GC6′), (GC6″), (GC7), (GC7′), (GC7″), (GC7″), (GC7″), (GC8), (GC8′), (GC9), (GC9′), (GC9″) or (GC9″), wherein the gelled confection comprises at least one coloring agent.

Therefore, the present invention also relates to a gelled confection (GC10′), which is gelled confection (GC10), wherein the at least one coloring agent can be a natural coloring agent and/or an artificial coloring agent.

Therefore, the present invention also relates to a gelled confection (GC10″), which is gelled confection (GC10) or (GC10′), wherein the amount of the at least one coloring agent is less than 1 wt-%, based on the total weight of the gelled confection.

Therefore, the present invention also relates to a gelled confection (GC10″), which is gelled confection (GC10) or (GC10′), wherein the amount of the at least one coloring agent is 0.01 to 1 wt-%, based on the total weight of the gelled confection.

The gelled confection according to the present invention can comprise further (non-essen-tial) auxiliary ingredients, such as pH buffers, antioxidants, divalent salts (such as Ca salt), etc. Such additional auxiliary ingredients may be present in the amount of up to 10 wt-%, based on the total weight of the gelled confection.

Therefore, the present invention also relates to a gelled confection (GC11), which is gelled confection (GC), (GC1), (GC1′), (GC1″), (GC1″), (GC1″), (GC2), (GC3), (GC3′), (GC4), (GC4′), (GC5), (GC5′), (GC5″), (GC5″), (GC6), (GC6′), (GC6″), (GC7), (GC7′), (GC7″), (GC7″), (GC7″), (GC8), (GC8′), (GC9), (GC9′), (GC9″), (GC9″), (GC10), (GC10′), (GC10″) or (GC10″), wherein the gelled confection comprises at least one auxiliary ingredient.

Therefore, the present invention also relates to a gelled confection (GC11′), which is gelled confection (GC11), wherein the at least one auxiliary ingredient is chosen from the group consisting of pH buffers, antioxidants and divalent salts (such as Ca salt).

Therefore, the present invention relates to a gelled confection (GC11″), which is the gelled confection (GC11) or (GC11′), wherein the amount of the auxiliary ingredient is up to 10 wt-%, based on the total weight of the gelled confection.

It is very usual that at least one antioxidant is used in the gelled confection. Any commonly known antioxidants can used. Suitable antioxidants are i.e. green tea extract, ascorbic acid, rosemary extract, and tocopherols. Such an antioxidant (or mixture of antioxidants) is used in an amount of 0.01-2.0 wt-%, based on the total weight of the gelled confection (preferred 0.05-1.0 wt-% based on the total weight of the gelled confection).

Therefore, the present invention relates to a gelled confection (GC11″), which is the gelled confection (GC11), wherein at least one antioxidant is chosen from the group consisting of green tea extract, ascorbic acid, rosemary extract, tocopherols, astaxanthin, and mixtures thereof.

Therefore, the present invention relates to a gelled confection (GC11″), which is the gelled confection (GC11″), wherein the amount of the at least one antioxidant is 0.01-2.0 wt-%, based on the total weight of the gelled confection.

Therefore, the present invention relates to a gelled confection (GC11″), which is the gelled confection (GC11″), wherein the amount of the at least one antioxidant is 0.05-1.0 wt-% based on the total weight of the gelled confection.

Furthermore, the gelled confection according to the present invention can also comprise further active ingredients (next to the PUFAs).

Preferred active ingredients for the embodiment of the present invention may include vitamins, HMOs, minerals, nutraceuticals, glycosaminoglycan or its active members, amino acids or combination thereof that are useful in human or animal nutrition.

Such additional active ingredients may be present in amount of up to 10 wt-%, based on the total weight of the gelled confection.

Therefore, the present invention also relates to a gelled confection (GC12), which is gelled confection (GC), (GC1), (GC1′), (GC1″), (GC1″), (GC1″), (GC2), (GC3), (GC3′), (GC4), (GC4′), (GC5), (GC5′), (GC5″), (GC5″), (GC6), (GC6′), (GC6″), (GC7), (GC7′), (GC7″), (GC7″), (GC7″), (GC8), (GC8′), (GC9), (GC9′), (GC9″), (GC9″), (GC10), (GC10′), (GC10″), (GC10′″), (GC11), (GC11′), (GC11″), (GC11′″) (GC11″) or (GC11″), wherein gelled confection comprises at least one further active ingredient (next to the PUFAs).

Therefore, the present invention also relates to a gelled confection (GC12′), which is gelled confection (GC12), wherein the at least one further active ingredient is chosen from the group consisting of vitamins, HMOs, minerals, nutraceuticals, glycosaminoglycan or its active members and amino acids.

Therefore, the present invention also relates to a gelled confection (GC12″), which is gelled confection (GC12) or (GC12′), wherein the amount of at least one further active ingredient is up to 30 wt-%, based on the total weight of the gelled confection.

In an embodiment, the gelled confection further comprises an outer surface comprising a shell, coating, or modification to the outer surface of the gelled portion. In an embodiment, the outer surface of the gelled confection comprises sugar, such as granulated sugar. In an embodiment, the outer surface comprises a hard or soft candy shell. Modification of the outer surface can take many forms based on the desired taste and mouthfeel of the gelled confection.

A general way to produce the gelled confection according to the present invention is the following:

Typically, the gelled confections according to the present invention are generally produced as follows:
1. Blend pectin, sodium citrate, and around 10% of sugar. Add the blend to water (Pectin:water weight ratio=1:10) and hydrate pectin at 80-85° C. for 30 min.
2. Add around 80% of sugar and corn syrup to a vessel and cook to 90-95° C. (Oil bath temperature set to 110° C.).
3. Add hydrated pectin slurry (Step 1) into corn syrup/sugar slurry.
4. Blend ascorbic acid, dry mixed tocopherols, rosemary extract, green tea extract, the rest of sugar, and encapsulated particles comprising a PUFA as a powder. And then add water to make a paste/slurry (Powder:water weight ratio=1:0.5).
5. Add the slurry from step 4 into step 3, mix well until homogeneous and continue heating until Brix reaches 78% (Range 76%-80%).
6. Add flavor(s) and color into step 5 and mix well until homogeneous and check Brix (target 78%, range 76%-80%).
7. Prepare citric acid solution (Powder:water weight ratio=1:1) and add into step 6 and mix well. Check Brix (Target 78%, range 76%-80%).
8. Deposit into silicone molds.
9. Remove from mold and polish with carnauba wax after 24 hours.

### EXAMPLES

The invention is illustrated by the following Examples, which should not be construed to limit the scope of the inventions disclosed herein. All temperatures are given in ° C. and all parts and percentages are related to the weight. The PUFAs employed in the below examples and comparative examples are as follows:

| Ingredient | PUFA Form |
|---|---|
| life's ® Omega O33-P100 | Powder of encapsulated particles comprising |
| | a coacervate shell of gelatin and sodium |
| | polyphosphate encapsulating a PUFA |
| Driphorm ® life's ® | Spray dried powder; microencapsulated |
| Omega | DHA/EPA oil; not coacervate |
| DHA/EPA Powder 2 | Spray dried powder; DHA/EPA oil on gum |
| | acacia; not coacervate |
| life's ® Omega Ultra Oil | Oil |
| AlaskOmega ® TG Oil | Oil |
| life's ® Omega O1030DS | Oil |

To summarize the below examples and comparative examples, use of a powder of encapsulated particles comprising a coacervate shell resulted in improvements in initial fishy notes and/or stability over time over the comparative examples.

### Example 1. Pectin Based Gummy, 275 mg DHA+EPA/2 Pieces of Gummy (6 g)

| Ingredient | % |
|---|---|
| Pectin APC 165B | 2.35 |
| Water | 14.00 |
| Sugar | 33.00 |
| Corn syrup | 30.13 |
| Citric acid | 1.80 |
| Ascorbic acid | 0.09 |
| Dry mixed tocopherols | 0.10 |
| Rosemary extract | 0.09 |
| Green tea extract | 0.12 |
| Color | 0.25 |
| Natural Flavors | 2.20 |
| Sodium citrate | 0.20 |
| life's ® Omega O33-P100 | 15.67 |
| Total | 100.00 |

850 g batch size:
1. Blend pectin, sodium citrate, and around 10% of sugar. Add the blend to water (Pectin:water weight ratio=1:10) and hydrate pectin at 80-85° C. for 30 min.
2. Add around 80% of sugar and corn syrup to a vessel and cook to 90-95° C. (Oil bath temperature set to 110° C.).
3. Add hydrated pectin slurry (Step 1) into corn syrup/sugar slurry.
4. Blend ascorbic acid, dry mixed tocopherols, rosemary extract, green tea extract, the rest of sugar, and life's® Omega O33-P100 powder. And then add water to make a paste/slurry (Powder:water weight ratio=1:0.5).
5. Add the slurry from step 4 into step 3, mix well until homogeneous and continue heating until Brix reaches 78% (Range 76%-80%).
6. Add flavors and color into step 5 and mix well until homogeneous and check Brix (target 78%, range 76%-80%).
7. Prepare citric acid solution (Powder:water weight ratio=1:1) and add into step 6 and mix well. Check Brix (Target 78%, range 76%-80%).
8. Deposit into silicone molds.
9 Remove from mold and polish with carnauba wax after 24 hours.

DFC (Difference-from-control) results of Example 1 gummy:Difference-from-control-DFC sensory analysis is conducted to monitor overall differences, if any, between each test variable and control (without any PUFA) (Min 30 gummies/time point).

Trained panelists (n≤20) on the DFC scale are used to measure the overall difference from control or reference without control. Comments are captured to understand differences, if any. As can be seen in the table below, no fishy notes were detected during the DFC test.

| | Control | Example 1 |
|---|---|---|
| Overall Aromatic Intensity | 8 | 8 |
| Sweet | 9 | 8 |
| Sour | 3 | 3.5 |
| Bitter | 1 | 1 |
| Berry Complex | 4 | 4 |
| Citrus Complex | 2.5 | 2 |
| Sweet Aromatics | 1 | 0.5 |
| Fishy | 0 | 0 |
| Vitamin | 0 | 0 |
| Painty/Chemical | 0 | 0 |
| Medicinal | 0 | 0 |
| Astringency | 3 | 3.5 |
| Hardness | 5.5 | 4.5 |

### 6 Month Difference-from-Control (DFC) Sensory Test Results of Example 1

| Gummy Description | Initial | 1 month | 3 month | 6 month | Comments |
|---|---|---|---|---|---|
| Blind Control (No PUFA) | 1.5 | 1 | 1 | 1 | |
| Example 1 | 3* | 3** | 3** | 3** | Stable, no |
| | | | | | reportable |
| | | | | | off notes |

*Statistically but not meaningfully different from the control-exhibited citrus/sour and fruity differences
**Statistically but not meaningfully different from the control-panelists identified a less-fresh flavor.

Difference-from-Control scale:

0 = No Difference
1 = Very slight/trace
2 = Slight
3 = Moderate
4 = Definite
5 = Large Difference
6 = Very Large Difference

### DFC Sensory Stability Results:

Gummies were stable for 6 months. No fishy notes were detected during the DFC test.

### Example 2. Gelatin Based Gummy with 275 mg DHA+EPA/2 Pieces of Gummy (6 g)

| Ingredient | % |
|---|---|
| Pork gelatin | 6.00 |
| Water | 14.00 |
| Sugar | 33.00 |
| Corn syrup | 26.53 |
| Citric acid | 1.20 |
| Ascorbic acid | 0.09 |
| Dry mixed tocopherols | 0.10 |
| Rosemary extract | 0.09 |
| Green tea extract | 0.12 |
| Color | 0.80 |
| Natural flavors | 2.40 |
| life's ® Omega O33-P100 | 15.67 |
| Total | 100.00 |

850 g batch size:
1. Hydrate gelatin at 80-85° C. for 20 min (Gelatin powder:water weight ratio=1:2).
2. Add around 80% of sugar and corn syrup to a vessel and cook to 90-95° C. (Oil bath temperature set to 110° C.).
3. Add hydrated gelatin slurry (Step 1) into corn syrup/sugar slurry.
4. Blend ascorbic acid, dry mixed tocopherols, rosemary extract, green tea extract, the rest of sugar, and life's® Omega O33-P100 powder. And then add water to make a paste/slurry (Powder:water weight ratio=1:0.5).
5. Add the slurry from step 4 into step 3, mix well until homogeneous and continue heating until Brix reaches 78% (Range 76%-80%).
6. Add flavors and color into step 5 and mix well until homogeneous and check Brix (target 78%, range 76%-80%).
7. Prepare citric acid solution (Powder:water weight ratio=1:1) and add into step 6 and mix well. Check Brix (target 78%, range 76%-80%).
8. Deposit into silicone molds.
9. Remove from mold and polish with carnauba wax after 24 hours.

### Example 3. Pectin Based Gummy with 175 mg DHA+EPA and Premix/2 Pieces of Gummy (6 g)

| Ingredient | % |
|---|---|
| Pectin | 2.25 |
| Water | 14.00 |
| Sugar | 33.00 |
| Corn syrup | 30.33 |
| Citric acid | 1.00 |
| Ascorbic acid | 0.08 |
| Dry mixed tocopherols | 0.09 |
| Rosemary extract | 0.08 |
| Green tea extract | 0.12 |
| Color | 0.25 |
| Natural flavors | 1.80 |
| Vitamin/Mineral Mix 1 | 6.83 |
| life's ® Omega O33-P100 | 9.97 |
| Sodium citrate | 0.20 |
| Total | 100.00 |

### Formulation of Vitamin/Mineral Mix 1

| Ingredient | % w/w |
|---|---|
| DRY VITAMIN A PALMITATE 250 S/N | 2.9854 |
| DRY VITAMIN D3 100 SD/S | 3.4537 |
| Dry Natural Vitamin E SF | 17.796 |
| VITAMIN K1 1.0% SD GFP | 2.0722 |
| THIAMINE MONONITRATE | 0.0786 |
| RIBOFLAVIN UNIVERSAL | 0.0555 |
| Pyridoxine Hydrochloride | 1.0429 |
| BIOTIN 1.0% DCP | 1.05 |
| METAFOLIN ® | 0.1556 |
| Methylcobalamin 1% on DCP | 0.1124 |
| Ascorbic Acid | 43.5464 |
| Chromium Picolinate 1% (Cr) on M | 0.5154 |
| Potassium lodide 1% SD | 5.7905 |
| Manganese Bisglycinate Chelate M | 1.9367 |
| Molybdenum Glycinate Chelate Mo | 0.2651 |
| Sodium Selenite 1% SD | 1.8035 |
| Zinc Citrate Dihydrate | 9.932 |
| Inositol Hexanicotinate | 7.4081 |

850 g batch size:
1. Blend pectin, sodium citrate, and around 10% of sugar. Add the blend to water (Pectin:water weight ratio=1:10) and hydrate pectin at 80-85° C. for 30 min.
2. Add around 80% of sugar and corn syrup to a vessel and cook to 90-95° C. (Oil bath temperature set to 110° C.).
3. Add hydrated pectin slurry (Step 1) into corn syrup/sugar slurry.
4. Blend ascorbic acid, dry mixed tocopherols, rosemary extract, green tea extract, the rest of sugar, and life's® Omega O33-P100 powder. And then add water to make a paste/slurry (Powder:water weight ratio=1:0.5).
5. Add the slurry from step 4 into step 3, mix well until homogeneous and continue heating until Brix reaches 78% (Range 76%-80%).
6. Prepare premix paste (1:0.5 ratio of premix powder to water), and add premix paste to step 5 and mix well until homogeneous.
7. Add flavors and color into step 6 and mix well until homogeneous and check Brix (target 78%, range 76%-80%).
8. Prepare citric acid solution (Powder:water weight ratio=1:1) and add into step 7 and mix well. Check Brix (Target 78%, range 76%-80%).
9. Deposit into silicone molds.
10. Remove from mold and polish with carnauba wax after 24 hours.
6 Month Difference-from-control (DFC) Sensory Test Results of Example 3

| Gummy | | 1 | 3 | 6 | |
|---|---|---|---|---|---|
| Description | Initial | month | month | month | Comments |
| Blind Control | 2 | 1 | 1 | 1.5 | |
| (No Omega-3) | | | | | |
| Example 3 | 2* | 2* | 1* | 1.5* | Stable, no re- |
| | | | | | portable off |
| | | | | | notes |

*No samples were statistically different from the control. No meaningful comments as what a difference may indicate.

Difference-from-Control scale:

| | |
|---|---|
| 0 = | No Difference |
| 1 = | Very slight/trace |
| 2 = | Slight |
| 3 = | Moderate |
| 4 = | Definite |
| 5 = | Large Difference |
| 6 = | Very Large Difference |

DFC Sensory Stability Results:

Gummies were stable for 6 months. No fishy notes were detected during the DFC test.

### Example 4. Pectin Based Sugar Free Gummy with 245 mg DHA+EPA/2 Pieces of Gummy (6 g)

| Ingredient | % |
|---|---|
| DSM Pectin APC 165B | 2.25 |
| Water | 11.00 |
| Xylitol | 20.00 |
| Allulose Syrup | 23.00 |
| Maltitol Syrup | 25.41 |
| Citric acid | 1.70 |
| Ascorbic acid | 0.08 |
| Dry mixed tocopherols | 0.09 |
| Rosemary extract | 0.08 |
| Green tea extract | 0.12 |
| Color | 0.25 |
| Natural flavors | 1.80 |
| life's ® Omega O33-P100 | 14.02 |
| Sodium citrate | 0.20 |
| Total | 100.00 |

850 g batch size:
1. Blend pectin, sodium citrate, and around 10% of xylitol. Add the blend to water (Pectin:water weight ratio=1:10) and hydrate pectin at 80-85° C. for 30 min.
2. Add around 80% of xylitol and allulose/maltitol syrup to a vessel and cook to 90-95° C. (Oil bath temperature set to 110° C.).
3. Add hydrated pectin slurry (Step 1) into allulose/maltitol syrup/xylitol slurry.
4. Blend ascorbic acid, dry mixed tocopherols, rosemary extract, green tea extract, the rest of xylitol, and life's® Omega O33-P100 powder. And then add water to make a paste/slurry (Powder:water weight ratio=1:0.5).
5. Add the slurry from step 4 into step 3, mix well until homogeneous and continue heating until Brix reaches 78% (Range 76%-80%).
6. Add flavors and color into step 5 and mix well until homogeneous and check Brix (target 78%, range 76%-80%).
7. Prepare citric acid solution (Powder:water weight ratio=1:1) and add into step 6 and mix well. Check Brix (Target 78%, range 76%-80%).
8. Deposit into silicone molds.
9 Remove from mold and polish with carnauba wax after 24 hours.

### Example 5. Pectin Based Gummy with 120 mg DHA+EPA and Premix/2 Pieces of Gummy (6 g)

| Ingredient | % |
|---|---|
| Pectin | 2.10 |
| Water | 12.00 |
| Sugar | 33.00 |
| Corn syrup | 39.24 |
| Citric acid | 0.50 |
| Ascorbic acid | 0.05 |
| Dry mixed tocopherols | 0.05 |
| Rosemary extract | 0.04 |
| Green tea extract | 0.07 |
| Color | 1.00 |
| Natural flavors | 1.79 |
| Sodium citrate | 0.32 |
| Vitamin/Mineral Mix 2 | 3.00 |
| life's ® Omega O33-P100 | 6.84 |
| Total | 100.00 |

### Formulation of Vitamin/Mineral Mix 2

| Ingredient | % w/w |
|---|---|
| DRY VITAMIN A PALMITATE 250 S/N | 1.472 |
| B-Carotene 15% LCS | 1.472 |
| DRY VITAMIN D3 100 SD/S | 9.2 |
| Dry Natural Vitamin E SF | 21.7716 |
| Vitamin K2 | 6.9 |
| THIAMINE MONONITRATE | 0.1579 |
| RIBOFLAVIN UNIVERSAL | 0.1752 |
| Pyridoxal 5 Phosphate | 1.2402 |
| d-Biotin 1% Trituration on Malto | 1.7173 |
| L-METHYLFOLATE | 0.252 |
| METHYLCOBALAMIN 1% DCP | 0.216 |
| Choline Bitartrate with AC | 34.3921 |
| Potassium lodide 10 % on Maltode | 0.9477 |
| Zinc Citrate Dihydrate | 3.8702 |
| Sugar Icing | 16.2158 |

850 g batch size:
1. Blend pectin, sodium citrate, and around 10% of sugar. Add the blend to water (Pectin:water weight ratio=1:10) and hydrate pectin at 80-85° C. for 30 min.
2. Add around 80% of sugar and corn syrup to a vessel and cook to 90-95° C. (Oil bath temperature set to 110° C.).
3. Add hydrated pectin slurry (Step 1) into corn syrup/sugar slurry.
4. Blend ascorbic acid, dry mixed tocopherols, rosemary extract, green tea extract, the rest of sugar, and life's® Omega O33-P100 powder. And then add water to make a paste/slurry (Powder:water weight ratio=1:0.5).
5. Add the slurry from step 4 into step 3, mix well until homogeneous and continue heating until Brix reaches 78% (Range 76%-80%).
6. Prepare premix paste (1:0.5 ratio of premix powder to water), and add premix paste to step 5 and mix well until homogeneous.
7. Add flavors and color into step 6 and mix well until homogeneous and check Brix (target 78%, range 76%-80%).
8. Prepare citric acid solution (Powder:water weight ratio=1:1) and add into step 7 and mix well. Check Brix (Target 78%, range 76%-80%).
9. Deposit into silicone molds.
10. Remove from mold and polish with carnauba wax after 24 hours.

DA (Descriptive Analysis) results of Example 5 after being stored at ambient condition after 6 months. Descriptive Analysis-conduct “DA” with a trained sensory panel to monitor key flavor attributes/notes and intensities at 6-month ambient storage (Min 20 gum-mies/time point). The descriptive analysis panel measured the intensities or strengths of the flavor attributes using the universal Spectrum scale of 0-15 where 0=not detected and 15=very high intensity.

| | Example 5 |
|---|---|
| Overall Aromatic Intensity | 7.5 |
| Sweet | 9 |
| Sour | 3.5 |
| Bitter | 1.5 |
| Berry Complex | 3 |
| Citrus Complex | 4 |
| Sweet Aromatics | 1 |
| Fishy | 0 |
| Vitamin | 1 |
| Painty/ | 0 |
| Chemical | |
| Medicinal | 0.5 |
| Astringency | 3.5 |
| Hardness | 4.5 |

DA Sensory Stability Results:

Gummies were stable for 6 months. No fishy notes were detected during the DA tests.

### Example 6. Pectin based gummy, 800 mg DHA+EPA/2 pieces of gummy (15 g)

| Ingredient | % |
|---|---|
| Pectin APC 165B | 2.10 |
| Water | 13.38 |
| Sugar | 33.00 |
| Corn syrup | 28.00 |
| Citric acid | 2.40 |
| Ascorbic acid | 0.09 |
| Dry mixed tocopherols | 0.10 |
| Rosemary extract | 0.09 |
| Green tea extract | 0.12 |
| Color | 0.40 |
| Natural Flavors | 2.40 |
| Sodium citrate | 1.30 |
| life's ® Omega O33-P100 | 0.20 |
| Total | 100.00 |

850 g batch size:
1. Blend pectin, sodium citrate, and around 10% of sugar. Add the blend to water (Pectin:water weight ratio=1:10) and hydrate pectin at 80-85° C. for 30 min.
2. Add around 80% of sugar and corn syrup to a vessel and cook to 90-95° C. (Oil bath temperature set to 110° C.).
3. Add hydrated pectin slurry (Step 1) into corn syrup/sugar slurry.
4. Blend ascorbic acid, dry mixed tocopherols, rosemary extract, green tea extract, the rest of sugar, and life's® Omega O33-P100 powder. And then add water to make a paste/slurry (Powder:water weight ratio=1:0.5).
5. Add the slurry from step 4 into step 3, mix well until homogeneous and continue heating until Brix reaches 78% (Range 76%-80%).
6. Add flavors and color into step 5 and mix well until homogeneous and check Brix (target 78%, range 76%-80%).
7. Prepare citric acid solution (Powder:water weight ratio=1:1) and add into step 6 and mix well. Check Brix (Target 78%, range 76%-80%).
8. Deposit into silicone molds.
9. Remove from mold and polish with carnauba wax after 24 hours.

Difference-from-control-DFC sensory analysis is conducted to monitor overall differences, if any, between each test variable and control (without any PUFA) (Min 30 gum-mies/time point). Trained panelists (n≤20) on the DFC scale are used to measure the overall difference from control or reference without control. Comments are captured to understand differences.

6 Month Difference-from-control (DFC) Sensory Test Results of Example 6

| Gummy | | 1 | 3 | 6 | |
|---|---|---|---|---|---|
| Description | Initial | month | month | month | Comments |
| Blind Control | 1.3 | 1.3 | 1.9 | 1.3 | |
| (No Omega-3) | | | | | |
| Example 6 | 2.0* | 1.7* | 2.3* | 2.5* | Stable, no report- |
| | | | | | able off notes |

*Statistically but not meaningfully different from the control- panelists identified no reportable off notes.

Difference-from-Control scale:

| | |
|---|---|
| 0 = | No Difference |
| 1 = | Very slight/trace |
| 2 = | Slight |
| 3 = | Moderate |
| 4 = | Definite |
| 5 = | Large Difference |
| 6 = | Very Large Difference |

DFC Sensory Stability Results:

Gummies were stable for 6 months. No fishy notes were detected during the DFC test.

### Comparative Example 1. High Omega 3 Pectin Gummies (50 mg DHA+EPA/6 g Serving, Life's® Omega Ultra Oil)

| Ingredient | % |
|---|---|
| Pectin | 2.10 |
| Water | 12.00 |
| Sugar | 33.00 |
| Corn Syrup | 47.93 |
| Citric Acid | 0.50 |
| Ascorbic Acid | 0.03 |
| Mixed Tocopherols | 0.04 |
| Rosemary Extract | 0.02 |
| Green Tea Extract | 0.05 |
| Beta-Carotene Emulsion Red Stock Solution | 1.00 |
| Natural Flavors | 1.70 |
| Sodium Citrate | 0.32 |
| life's ® Omega Ultra Oil | 1.32 |
| Total | 100.00 |

1. Blend pectin, sodium citrate, and around 10% of sugar. Add the blend to water (Pectin:water weight ratio=1:10) and hydrate pectin at 80-850 C for 30 min.
2. Add around 80% of sugar and corn syrup to a vessel and cook to 90-95° C. (Oil bath temperature set to 1100 C).
3. Add hydrated pectin slurry (Step 1) into corn syrup/sugar slurry.
4. Blend ascorbic acid, dry mixed tocopherols, rosemary extract, green tea extract, the rest of sugar. And then add water to make a paste/slurry (Powder:water weight ratio=1:0.5).
5. Add the slurry from step 4 into step 3, mix well until homogeneous and continue heating until Brix reaches 78% (Range 76%-80%).
6. Add flavors, oil, and color into step 5 and mix well until homogeneous and check Brix (target 78%, range 76%-80%).
7. Prepare citric acid solution (Powder:water weight ratio=1:1) and add into step 6 and mix well. Check Brix (Target 78%, range 76%-80%).
8. Deposit into silicone molds.
9. Remove from mold and polish with carnauba wax after 24 hours.

DFC Sensory Stability Results:Initially the gummies were notably fishy; off-flavor was observed during bench screening at 6 months.

### Comparative Example 2. High Omega 3 Pectin Gummies (50 mg DHA+EPA/6 g Serving, Alaska Fish Oil)

| Ingredient | % |
|---|---|
| Pectin | 2.10 |
| Water | 12.00 |
| Sugar | 33.00 |
| Corn Syrup | 47.96 |
| Citric Acid | 0.50 |
| Ascorbic Acid | 0.03 |
| Mixed Tocopherols | 0.04 |
| Rosemary Extract | 0.02 |
| Green Tea Extract | 0.05 |
| Beta-Carotene Emulsion Red Stock Solution | 1.00 |
| Natural flavors | 1.70 |
| Sodium Citrate | 0.32 |
| AlaskOmega ® TG Oil | 1.28 |
| Total | 100.00 |

1. Blend pectin, sodium citrate, and around 10% of sugar. Add the blend to water (Pectin:water weight ratio=1:10) and hydrate pectin at 80-850 C for 30 min.
2. Add around 80% of sugar and corn syrup to a vessel and cook to 90-95° C. (Oil bath temperature set to 1100 C).
3. Add hydrated pectin slurry (Step 1) into corn syrup/sugar slurry.
4. Blend ascorbic acid, dry mixed tocopherols, rosemary extract, green tea extract, the rest of sugar. And then add water to make a paste/slurry (Powder:water weight ratio=1:0.5).
5. Add the slurry from step 4 into step 3, mix well until homogeneous and continue heating until Brix reaches 78% (Range 76%-80%).
6. Add flavors, oil, and color into step 5 and mix well until homogeneous and check Brix (target 78%, range 76%-80%).
7. Prepare citric acid solution (Powder:water weight ratio=1:1) and add into step 6 and mix well. Check Brix (Target 78%, range 76%-80%).
8. Deposit into silicone molds.
9. Remove from mold and polish with carnauba wax after 24 hours.

DFC Sensory Stability Results: Gummies were notably fishy by 3-months and remained off-flavored at the 8-month evaluation.

### Comparative Example 3. High Omega 3 Pectin Gummies (50 mg DHA+EPA/6 g Serving, Life's® Omega O1030DS Oil)

| Ingredient | % |
|---|---|
| Pectin | 2.10 |
| Water | 12.00 |
| Sugar | 33.00 |
| Corn Syrup | 47.51 |
| Citric Acid | 0.50 |
| Ascorbic Acid | 0.03 |
| Mixed Tocopherols | 0.04 |
| Rosemary Extract | 0.02 |
| Green Tea Extract | 0.05 |
| Beta-Carotene Emulsion Red Stock Solution | 1.00 |
| Natural flavors | 1.70 |
| Sodium Citrate | 0.32 |
| life's ® Omega O1030DS | 1.73 |
| Total | 100.00 |

1. Blend pectin, sodium citrate, and around 10% of sugar. Add the blend to water (Pectin:water weight ratio=1:10) and hydrate pectin at 80-850 C for 30 min.
2. Add around 80% of sugar and corn syrup to a vessel and cook to 90-95° C. (Oil bath temperature set to 1100 C).
3. Add hydrated pectin slurry (Step 1) into corn syrup/sugar slurry.
4. Blend ascorbic acid, dry mixed tocopherols, rosemary extract, green tea extract, the rest of sugar. And then add water to make a paste/slurry (Powder:water weight ratio=1:0.5).
5. Add the slurry from step 4 into step 3, mix well until homogeneous and continue heating until Brix reaches 78% (Range 76%-80%).
6. Add flavors oil, and color into step 5 and mix well until homogeneous and check Brix (target 78%, range 76%-80%).
7. Prepare citric acid solution (Powder:water weight ratio=1:1) and add into step 6 and mix well. Check Brix (Target 78%, range 76%-80%).
8. Deposit into silicone molds.
9. Remove from mold and polish with carnauba wax after 24 hours.

DFC Sensory Stability Results: Gummies were perceivably fishy by 3 months, with the off-flavor becoming more notable at the 8-month evaluation.

### Comparative Example 4. Pectin Gummies with Spray-Dried Powder (100 mg DHA+EPA/6 g Serving)

| Ingredient | % |
|---|---|
| Pectin | 2.10 |
| Water | 12.00 |
| Sugar | 33.00 |
| Corn Syrup | 44.60 |
| Citric Acid | 0.50 |
| Ascorbic Acid | 0.03 |
| Mixed Tocopherols | 0.04 |
| Rosemary Extract | 0.02 |
| Green Tea Extract | 0.05 |
| Beta-Carotene Emulsion Red Stock Solution | 1.00 |
| Natural Flavors | 1.70 |
| Sodium Citrate | 0.32 |
| DHA/EPA Powder 2 | 4.65 |
| Total | 100.00 |

Label Claim of DHA+EPA=100 mg/serving
1. Blend pectin, sodium citrate, and around 10% of sugar. Add the blend to water (Pectin:water weight ratio=1:10) and hydrate pectin at 80-85° C. for 30 min.
2. Add around 80% of sugar and corn syrup to a vessel and cook to 90-95° C. (Oil bath temperature set to 110° C.).
3. Add hydrated pectin slurry (Step 1) into corn syrup/sugar slurry.
4. Blend ascorbic acid, dry mixed tocopherols, rosemary extract, green tea extract, and DHA/EPA Powder 2. And then add water to make a paste/slurry (Powder:water weight ratio=1:0.5).
5. Add the slurry from step 4 into step 3, mix well until homogeneous and continue heating until Brix reaches 78% (Range 76%-80%).
6. Add flavors, paste/slurry, and color into step 5 and mix well until homogeneous and check Brix (target 78%, range 76%-80%).
7. Prepare citric acid solution (Powder:water weight ratio=1:1) and add into step 6 and mix well. Check Brix (Target 78%, range 76%-80%).
8. Deposit into silicone molds.
9. Remove from mold and polish with carnauba wax after 24 hours.

DFC Sensory Stability Results:

Initially the gummies were notably fishy. No sensory/stability tests conducted.

### Comparative Example 5. Pectin Gummies with Spray-Dried Powder (100 mg DHA+EPA/6 g Serving)

| Ingredient | % |
|---|---|
| Pectin | 2.10 |
| Water | 12.00 |
| Sugar | 33.00 |
| Corn Syrup | 41.40 |
| Citric Acid | 0.50 |
| Ascorbic Acid | 0.03 |
| Mixed Tocopherols | 0.04 |
| Rosemary Extract | 0.02 |
| Green Tea Extract | 0.05 |
| Beta-Carotene Emulsion Red Stock Solution | 1.00 |
| Natural flavors | 1.70 |
| Sodium Citrate | 0.32 |
| Driphorm ® life's® Omega | 7.85 |
| Total | 100.00 |

Label Claim of DHA+EPA=100 mg/Serving
1. Blend pectin, sodium citrate, and around 10% of sugar. Add the blend to water (Pectin:water weight ratio=1:10) and hydrate pectin at 80-85° C. for 30 min.
2. Add around 80% of sugar and corn syrup to a vessel and cook to 90-95° C. (Oil bath temperature set to 110° C.).
3. Add hydrated pectin slurry (Step 1) into corn syrup/sugar slurry.
4. Blend ascorbic acid, dry mixed tocopherols, rosemary extract, green tea extract, and Driphorm® life's® Omega powder. And then add water to make a paste/slurry (Powder:water weight ratio=1:0.5).
5. Add the slurry from step 4 into step 3, mix well until homogeneous and continue heating until Brix reaches 78% (Range 76%-80%).
6. Add flavors paste/slurry, and color into step 5 and mix well until homogeneous and check Brix (target 78%, range 76%-80%).
7. Prepare citric acid solution (Powder:water weight ratio=1:1) and add into step 6 and mix well. Check Brix (Target 78%, range 76%-80%).
8. Deposit into silicone molds.
9. Remove from mold and polish with carnauba wax after 24 hours.

DFC Sensory Stability Results:

Initially the gummies were notably fishy. No sensory/stability tests conducted.

1. A gelled confection comprising:
(i) encapsulated particles comprising a coacervate shell encapsulating at least one PUFA,
(ii) at least one gelling substance, and
(iii) water,
wherein the content of the at least one PUFA is at least 10 mg/g of the gelled confection.

2. The gelled confection of claim 1, wherein the at least one PUFA is chosen from the group consisting of PUFA having from 16 to 24 carbon atoms and having multiple unsaturated carbon-carbon double bonds.

3. The gelled confection of claim 1, wherein the at least one PUFA is chosen from the group consisting of eicosapentaenoic acid (EPA), docosapentaenoic acid (DPA), docosahexaenoic acid (DHA), and a mixture thereof.

4. The gelled confection according to any of the preceding claims, wherein the encapsulated particles comprising a coacervate shell encapsulating a PUFA are present in an amount of from 10 to 20 wt %, based on the total weight of the gelled confection.

5. The gelled confection according to any of the preceding claims, wherein the coacervate shell comprises a coacervate between two or more polymer components.

6. The gelled confection according to any of the preceding claims, wherein the coacervate shell comprises a coacervate between a first polymer component comprises-ing gelatin and a second polymer component.

7. The gelled confection according to any of the preceding claims, wherein the coacervate shell comprises a coacervate between a first polymer component comprises-ing gelatin and a second polymer component comprising a polyphosphate.

8. The gelled confection according to any of the preceding claims, wherein the encapsulated particles have an average diameter of from 50 to 500 μm, preferably 20-250 μm, more preferably 30-150 μm.

9. The gelled confection according to any of the preceding claims, wherein the at least one gelling substance is chosen from the group consisting of gelatin, pectin, starches and any other hydrocolloids.

10. The gelled confection according to any of the preceding claims, wherein the amount of the at least one gelling agent is between 0.5 and 20 wt-%, based on the total weight of the gelled confection.

11. The gelled confection according to any of the preceding claims, wherein the gelled confection comprises at least one sugar (monosaccharides and/or disaccharides).

12. The gelled confection according to claim 11, wherein the monosaccharides and/or disaccharides is chosen from the group consisting of fructose, galactose, glucose, lactose, maltose, and sucrose.

13. The gelled confection according to claim 11 or claim 12, wherein the amount of the sugar (monosaccharides and/or disaccharides) in the gelled confection is between 15 to 45 wt-%, based on the total weight of the gelled confection.

14. The gelled confection according to any of the preceding claims, wherein the gelled confection further comprises syrup (such as corn syrup, molasses, cane or beet syrup, malt extract, honey, maple syrup, agave, yacon, rice syrup, tapioca syrup, oat syrup).

15. The gelled confection according to claim 14, wherein the syrup is present in an amount of between 10 and 50 wt-%, based on the total weight of the gelled confection.

16. The gelled confection according to any of the preceding claims, wherein the gelled confection comprises at least one antioxidant chosen from the group consisting of green tea extract, ascorbic acid, rosemary extract, tocopherols, astaxanthin, and mixtures thereof.

17. The gelled confection according to any of the preceding claims, wherein the gelled confection comprises at least one flavor ingredient.

18. The gelled confection according to claim 17, wherein the total amount of flavor ingredients in the gelled confection is less than 5 wt-%, preferably 0.01 to 5 wt-%, more preferably 1.0 to 3.0 wt-%, based on the total weight of the gelled confection.

19. The gelled confection according to any of the preceding claims, wherein the gelled confection comprises at least one further active ingredient (next to the PUFAs).

20. The gelled confection according to any one of the preceding claims, wherein the gelled confection further comprises an outer surface comprising a shell, coating, or modification to the outer surface of the gelled confection.

21. The gelled confection according to any one of the preceding claims, wherein the content of the at least one PUFA is from 10 to 60 mg per g of the gelled confection.
